(19) United States
(12) Patent Application Publication
(10) Pub. No.: US 2026/0181257 A1
(43) Pub. Date: Jun. 25, 2026

(54) ELECTRONIC DEVICE, METHOD, AND NON-TRANSITORY COMPUTER-READABLE STORAGE MEDIUM FOR GENERATING CYLINDRICAL PANORAMA IMAGE

(71) Applicant: Samsung Electronics Co., Ltd., Suwon-si (KR)

(72) Inventors: Jongkwang KIM, Suwon-si (KR); Kyuwon KIM, Suwon-si (KR); Jongkyu KIM, Suwon-si (KR); Kihyung NAM, Suwon-si (KR); Chulju YANG, Suwon-si (KR); Heekuk LEE, Suwon-si (KR); Albert SAA-GARRIGA, Staines (GB); Wayne PRICE, Staines (GB)

(21) Appl. No.: 19/307,506

(22) Filed: Aug. 22, 2025

Related U.S. Application Data
(63) Continuation of application No. PCT/KR2025/012433, filed on Aug. 14, 2025.

(30) Foreign Application Priority Data
Dec. 19, 2024 (KR) 10-2024-0191936
Jan. 13, 2025 (KR) 10-2025-0005072
Feb. 11, 2025 (KR) 10-2025-0017460

(51) Int. Cl. H04N 23/698; H04N 23/63; H04N 23/69; H04N 23/695

(52) U.S. Cl. CPC H04N 23/698; H04N 23/631; H04N 23/69; H04N 23/695

(57) ABSTRACT

An electronic device is provided. The electronic device includes at least one processor including processing circuitry, a display, and memory including one or more storage media, storing one or more programs configured to be executed by the at least one processor individually or collectively, wherein the one or more programs include instructions to cause the electronic device to obtain a first panorama image corresponding to a planar panorama image, detect an event to convert the first panorama image to a second panorama image, based on the detection, obtain a depth value of the first panorama image, obtain a curvature for generating a cylindrical panorama image, using the depth value of the first panorama image, based on the first panorama image, generate the second panorama image in accordance with the curvature, and display, via the display, a portion of the second panorama image.

### CROSS-REFERENCE TO RELATED APPLICATION(S)

This application is a continuation application, claiming priority under 35 U.S.C. § 365 (c), of an International application No. PCT/KR2025/012433, filed on Aug. 14, 2025, which is based on and claims the benefit of a Korean patent application number 10-2024-0191936, filed on Dec. 19, 2024, in the Korean Intellectual Property Office, of a Korean patent application number 10-2025-0005072, filed on Jan. 13, 2025, in the Korean Intellectual Property Office, and of a Korean patent application number 10-2025-0017460, filed on Feb. 11, 2025, in the Korean Intellectual Property Office, the disclosure of each of which is incorporated by reference herein in its entirety.

### TECHNICAL FIELD

The disclosure relates to an electronic device, a method, and a non-transitory computer-readable storage medium for generating a cylindrical panorama image.

### BACKGROUND ART

The electronic device may obtain a panorama image. The panorama image may be generated by a plurality of images being coupled. A field of view (FOV) of the panorama image may be larger than the FOV of each of the plurality of images. The electronic device may obtain the panorama image by performing feature matching on the plurality of images.

The above information is presented as background information only to assist with an understanding of the disclosure. No determination has been made, and no assertion is made, as to whether any of the above might be applicable as prior art with regard to the disclosure.

### DISCLOSURE

### Technical Solution

Aspects of the disclosure are to address at least the above-mentioned problems and/or disadvantages and to provide at least the advantages described below. Accordingly, an aspect of the disclosure is to provide an electronic device, a method, and a non-transitory computer-readable storage medium for generating a cylindrical panorama image.

Additional aspects will be set forth in part in the description which follows and, in part, will be apparent from the description, or may be learned by practice of the presented embodiments.

In accordance with an aspect of the disclosure, an electronic device is described. The electronic device may comprise at least one processor comprising processing circuitry, a display, and memory comprising one or more storage media storing one or more programs configured to be executed by the at least one processor individually or collectively. The one or more programs may include instructions to cause the electronic device to obtain a first panorama image corresponding to a planar panorama. The one or more programs may include instructions to cause the electronic device to detect an event to convert the first panorama image to a second panorama image. The one or more programs may include instructions to cause the electronic device to, based on the detection, obtain a depth value of the first panorama image. The one or more programs may include instructions to cause the electronic device to obtain a curvature for generating the second panorama image, using the depth value of the first panorama image. The one or more programs may include instructions to cause the electronic device to, based on the first panorama image, generate the second panorama image in accordance with the curvature. The one or more programs may include instructions to cause the electronic device to display, via the display, a portion of the second panorama image.

In accordance with another aspect of the disclosure, a method is described. The method may be executed in an electronic device comprising a display. The method may comprise obtaining a first panorama image corresponding to a planar panorama image. The method may comprise detecting an event to convert the first panorama image to a second panorama image. The method may comprise, based on the detection, obtaining a depth value of the first panorama image. The method may comprise obtaining a curvature for generating the second panorama image, using the depth value of the first panorama image. The method may comprise, based on the first panorama image, generating the second panorama image in accordance with the curvature. The method may comprise displaying, via the display, a portion of the second panorama image.

In accordance with another aspect of the disclosure, non-transitory computer readable storage medium is described. The non-transitory computer readable storage medium may store one or more programs. The one or more programs may comprise instructions to, when executed by an electronic device including a display, cause the electronic device to obtain a first panorama image corresponding to a planar panorama image. The one or more programs may comprise instructions to, when executed by the electronic device, cause the electronic device to detect an event to convert the first panorama image to a second panorama image. The one or more programs may comprise instructions to, when executed by the electronic device, cause the electronic device to, based on the detection, obtain a depth value of the first panorama image. The one or more programs may comprise instructions to, when executed by the electronic device, cause the electronic device to obtain a curvature for generating the second panorama image, using the depth value of the first panorama image. The one or more programs may comprise instructions to, when executed by the electronic device, cause the electronic device to, based on the first panorama image, generate the second panorama image in accordance with the curvature. The one or more programs may comprise instructions to, when executed by the electronic device, cause the electronic device to display, via the display, a portion of the second panorama image.

Other aspects, advantages, and salient features of the disclosure will become apparent to those skilled in the art from the following detailed description, which, taken in conjunction with the annexed drawings, discloses various embodiments of the disclosure.

### DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an example of distortion included in a planar panorama image according to an embodiment of the disclosure;

FIG. 2 is a simplified block diagram of an electronic device according to an embodiment of the disclosure;

FIG. 3 is a flowchart illustrating operations of an electronic device for generating a cylindrical panorama image according to an embodiment of the disclosure;

FIG. 4 illustrates an example of a user input for displaying a cylindrical panorama image according to an embodiment of the disclosure;

FIG. 5 illustrates an example of obtaining a depth value of a planar panorama image according to an embodiment of the disclosure;

FIG. 6 illustrates an example of cylindrical panorama images having different curvatures according to an embodiment of the disclosure;

FIG. 7 is a flowchart illustrating operations of an electronic device for displaying a portion of a cylindrical panorama image according to an embodiment of the disclosure;

FIG. 8 illustrates an example of an animation changed from a planar panorama image to a cylindrical panorama image according to an embodiment of the disclosure;

FIG. 9 illustrates an example of scrolling a cylindrical panorama image according to an embodiment of the disclosure;

FIGS. 10A and 10B illustrate an example of displaying a portion of a cylindrical panorama image to be viewed at a position separated from the cylindrical panorama image by a reference distance according to various embodiments of the disclosure;

FIG. 11A is a flowchart illustrating operations of an electronic device for displaying a lens flare effect on a portion of a cylindrical panorama image according to an embodiment of the disclosure;

FIG. 11B illustrates an example of a lens flare effect displayed in a portion of a cylindrical panorama image according to an embodiment of the disclosure; and

FIG. 12 is a block diagram of an electronic device in a network environment according to an embodiment of the disclosure.

Throughout the drawings, it should be noted that like reference numbers are used to depict the same or similar elements, features, and structures.

### MODE FOR INVENTION

The following description with reference to the accompanying drawings is provided to assist in a comprehensive understanding of various embodiments of the disclosure as defined by the claims and their equivalents. It includes various specific details to assist in that understanding, but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but are merely used by the inventor to enable a clear and consistent understanding of the disclosure. Accordingly, it should be apparent to those skilled in the art that the following description of various embodiments of the disclosure is provided for illustration purposes only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

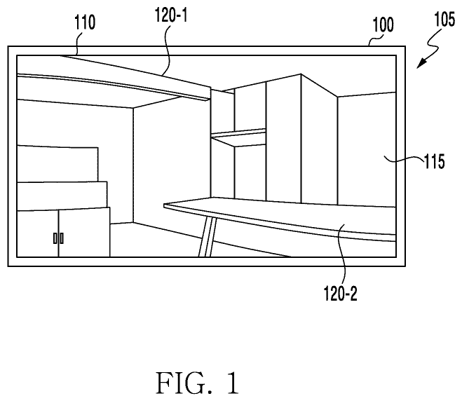

FIG. 1 illustrates an example of distortion included in a planar panorama image according to an embodiment of the disclosure.

Referring to FIG. 1, an electronic device 100 may be a device available to display a panorama image. For example, the electronic device 100 may be one of various forms of mobile devices such as smartphones (e.g., a bar-type smartphone, a foldable-type smartphone, or a rollable-type smartphone), a tablet, a wearable device, a cellular phone, a personal computer (PC) (e.g., a laptop and/or a desktop), and/or other similar computing devices having various form factors including circuits (or circuitry) for displaying the panorama image.

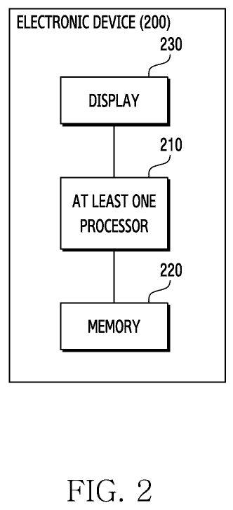

The electronic device 100 may include a display 110 (e.g., the display 230 of FIG. 2). For example, the display 110 may be used to display the panorama image. In a state 105, the electronic device 100 may display a planar panorama image 115 through the display 110. The planar panorama image 115 may be referred to as a two dimensional (2D) panorama image. For example, the planar panorama image 115 may be described as a panorama image in which a cylindrical panorama image is unfolded.

The planar panorama image 115 may be obtained by coupling a plurality of images. The plurality of images may be described as sequentially obtained images. The plurality of images may be coupled based on feature matching. The feature matching may be defined as coupling the plurality of images by connecting each of the corresponding features (or a feature point) in the plurality of images. An object included in the plurality of images may be bent or curved to connect features in the plurality of images on a plane. For example, the planar panorama image 115 in which the plurality of images is coupled may include objects 120-1 and 120-2. The objects 120-1 and 120-2 may represent subjects. In the planar panorama image 115 in which the plurality of images is coupled on the plane, the objects 120-1 and 120-2 may be represented in a bent way or in a curved way. In the planar panorama image 115, as the objects 120-1 and 120-2 are represented in the bent way or in the curved way, a user may feel uncomfortable. As the objects 120-1 and 120-2 are bent or curved, a method may be required to solve user's discomfort caused by distortion (e.g., barrel distortion) caused (or generated) in the planar panorama image 115.

To solve this inconvenience, the electronic device 100 may generate the cylindrical panorama image, using the planar panorama image 115. For example, in order to generate the cylindrical panorama image, a depth value of the planar panorama image 115 may be used. For example, the electronic device 100 may provide a panorama image with distortion compensated (or reduced) by displaying a portion of the cylindrical panorama image through the display 110.

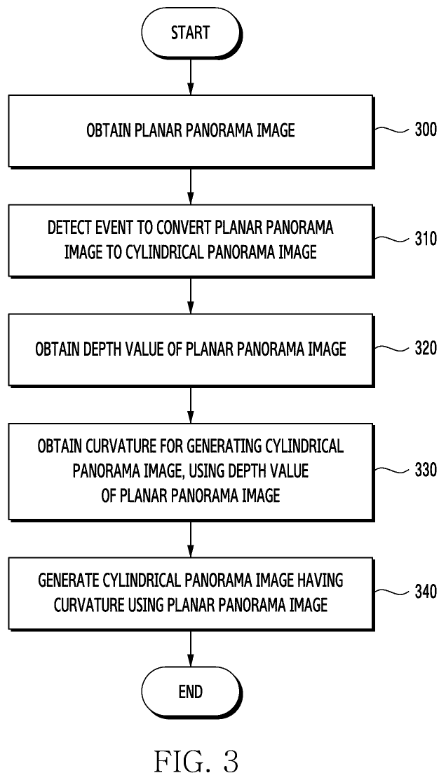

The electronic device 100 may execute operations to be exemplified in a description of FIGS. 3 to 9, 10A, 10B, 11A, and 11B to generate the cylindrical panorama image. The electronic device 100 may include components for executing the operations. The components may be exemplified in a description of FIG. 2.

FIG. 2 is a simplified block diagram of an electronic device according to an embodiment of the disclosure.

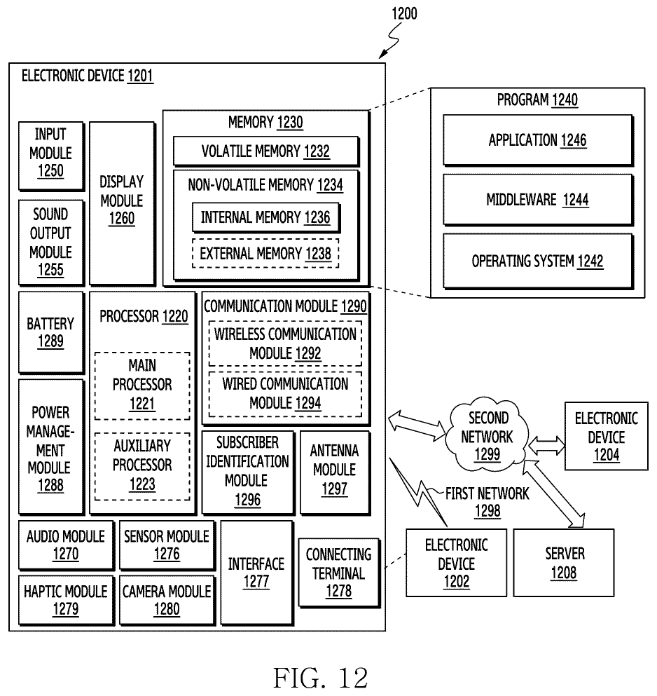

Referring to FIG. 2, an electronic device 200 may be one of various forms of mobile devices such as smartphones (e.g., a bar-type smartphone, a foldable-type smartphone, or a rollable-type smartphone), a tablet, a wearable device, a cellular phone, a personal computer (PC) (e.g., a laptop and/or a desktop), and/or other similar computing devices having various form factors. For example, the electronic device 200 may include the electronic device 100 of FIG. 1 or may correspond to the electronic device 100 of FIG. 1. For example, the electronic device 200 may include at least a portion of an electronic device 1201 of FIG. 12, or may correspond to at least a portion of the electronic device 1201 of FIG. 12. The electronic device 200 may include at least one processor 210 (e.g., a processor 1220 of FIG. 12), memory 220 (e.g., memory 1230 of FIG. 12), and a display 230 (e.g., a display module 1260 of FIG. 12).

The at least one processor 210 may include processing circuitry. For example, the at least one processor 210 may include a central processing unit (CPU) (e.g., including the processing circuitry). For example, the at least one processor 210 may include a graphic processing unit (GPU) (e.g., including the processing circuitry) and/or a neural processing unit (NPU) (e.g., including the processing circuitry). For example, the at least one processor 210 may be described as an application processor. For example, the at least one processor 210 may be configured to control the memory 220 and the display 230. The at least one processor 210 may be configured to execute instructions stored in the memory 220 individually or collectively to cause the electronic device 200 (or the electronic device 100) to perform at least a portion of operations exemplified in a description of FIG. 1. The at least one processor 210 may be configured to execute instructions stored in the memory 220 to cause the electronic device 200 to perform at least a portion of operations exemplified in a description of FIGS. 3 to 9, 10A, 10B, 11A, and 11B.

The term “processor” used in this document, including a scope of claims, may include various processing circuitry including at least one processor, and one or more of the at least one processor may be configured to perform various functions described below individually and/or collectively in a distributed manner. As used below, in case that “processor”, “at least one processor”, and “one or more processors” are described as configured to perform various functions, these terms are not limited to, for example, and cover situations in which a processor performs a portion of cited functions and another (other) processor(s) performs another portion of the cited functions, and also cover situations in which one processor may perform all of the cited functions. Additionally, the at least one processor may include a combination of processors that perform various functions listed/initiated, for example, in the distributed manner. At least one processor may execute program instructions to achieve or perform the various functions.

The memory 220 may include one or more storage mediums. For example, the memory 220 may store various data used by at least one component (e.g., the at least one processor 210 and/or the display 230) of the electronic device 200. For example, the data may include input data or output data on software and a related command. The memory 220 may include volatile memory or non-volatile memory.

The display 230 may output visualized information under control of the at least one processor 210. For example, the display 230 may include a flat panel display (FPD) and/or electronic paper. The FPD may include a liquid crystal display (LCD), a plasma display panel (PDP), and/or one or more light emitting diodes (LEDs). For example, the LED may include an organic LED (OLED). The display 230 may include a touch sensor set to detect a touch, or a pressure sensor set to measure an intensity of force that occurred by the touch. For example, the display 230 may be configured to display a portion of a cylindrical panorama image. For example, the display 230 may be configured to receive a user input. For example, the display 230 supporting a touch function may be referred to as a touch screen.

The electronic device 200 illustrated in FIG. 2 may execute at least a portion of the operations exemplified in the description of FIGS. 3 to 9, 10A, 10B, 11A, and 11B. For example, the operations exemplified in the description of FIGS. 3 to 9, 10A, 10B, 11A, and 11B may be caused by (or in) the electronic device 200 under control of the at least one processor 210.

FIG. 3 is a flowchart illustrating operations of an electronic device for generating a cylindrical panorama image according to an embodiment of the disclosure.

Referring to FIG. 3, in operation 300, at least one processor 210 may obtain a planar panorama image (e.g., the planar panorama image 115 of FIG. 1). For example, the planar panorama image may be received from an external electronic device or may be generated in the electronic device. For example, the at least one processor 210 may receive a shooting input for obtaining a panorama image while displaying a preview image. The at least one processor 210 may obtain a plurality of images, based on the photographing input for obtaining the panorama image. The plurality of images may include the images sequentially obtained as a posture of the electronic device 200 on the same (or substantially the same) position is changed. The at least one processor 210 may obtain the planar panorama image by coupling the plurality of images, based on feature matching.

In operation 310, the at least one processor 210 may detect an event to convert the planar panorama image to the cylindrical panorama image. The planar panorama image may be referred to as a 2D panorama image, and the cylindrical panorama image may be referred to as a 3D panorama image. For example, the at least one processor 210 may detect the event to convert the planar panorama image to the cylindrical panorama image, based on obtaining the planar panorama image. The at least one processor 210 may detect the event to convert the planar panorama image to the cylindrical panorama image, based on identifying the planar panorama image satisfying a reference condition among the obtained planar panorama images. For example, the reference condition may be preset or may be set (or changed) by a user.

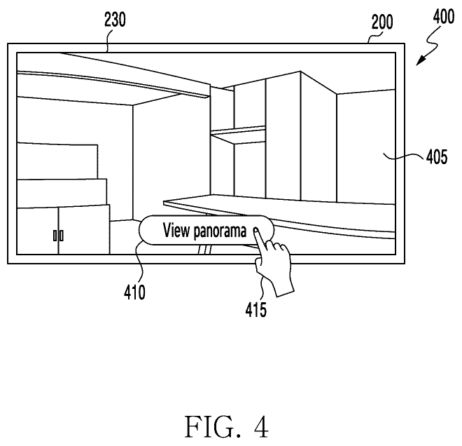

The at least one processor 210 may receive a user input for displaying the cylindrical panorama image. The at least one processor 210 may detect the event to convert the planar panorama image to the cylindrical panorama image, based on the user input for displaying the cylindrical panorama image. The user input for displaying the cylindrical panorama image is exemplified in a description of FIG. 4.

FIG. 4 illustrates an example of a user input for displaying a cylindrical panorama image according to an embodiment of the disclosure.

Referring to FIG. 4, in a state 400, at least one processor 210 may display a planar panorama image 405 via a display 230. The at least one processor 210 may simultaneously display an executable object (or a user interface (UI) object) 410 indicating display of the cylindrical panorama image via the display 230 with the planar panorama image 405. For example, the executable object 410 may include text (e.g., a “view panorama”) indicating the display of the cylindrical panorama image.

The at least one processor 210 may receive (or identify) a user input 415 on the executable object 410. For example, the user input 415 may include a touch input having a contact point on the executable object 410. The user input 415 may be received via the display 230 (e.g., a touch screen). For example, the user input 415 may be received via a cursor (or a pointer) controlled by an external electronic device (e.g., a mouse) connected to the electronic device 200. The user input 415 may include a voice input (or a speech input) received via a microphone of the electronic device 200. However, it is not limited thereto.

The at least one processor 210 may detect the event to convert the planar panorama image to the cylindrical panorama image based on the user input 415. The at least one processor 210 may perform an operation 320 of FIG. 3, based on the user input 415.

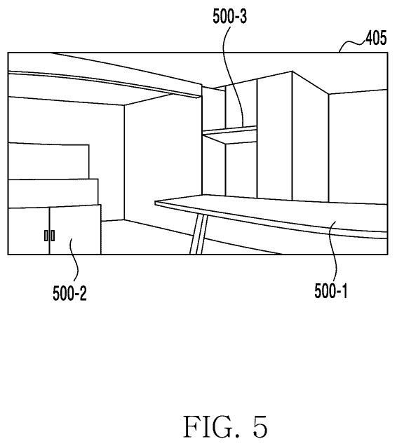

Referring back to FIG. 3, in operation 320, the at least one processor 210 may obtain a depth value of the planar panorama image. For example, the depth value of the planar panorama image may be referred to as a focal length and/or a depth of field (or depth of focus) (DoF). The at least one processor 210 may perform object detection included in the planar panorama image to obtain the depth value of the planar panorama image. The at least one processor 210 may obtain depth values of each of the detected objects in the planar panorama image. The at least one processor 210 may obtain the depth value of the planar panorama image by using the depth values of each of the detected objects in the planar panorama image. Obtaining the depth value of the planar panorama image will be illustrated in a description of FIG. 5.

FIG. 5 illustrates an example of obtaining a depth value of a planar panorama image according to an embodiment of the disclosure.

Referring to FIG. 5, a planar panorama image 405 may include objects 500-1, 500-2, and 500-3. The objects 500-1, 500-2, and 500-3 may represent subjects. The at least one processor 210 may identify the objects 500-1, 500-2, and 500-3 by performing object detection on the planar panorama image 405. For example, in order to perform the object detection, a trained model may be used. The trained model may include an artificial intelligence (AI) model, a machine learning model, and/or a deep learning model. The at least one processor 210 may obtain depth values on each of the identified objects 500-1, 500-2, and 500-3 by performing depth estimation on the planar panorama image 405. The depth estimation may be described, using a 2D image, as obtaining (or estimating) a depth value of each pixel included in the 2D image. For example, in order to perform the depth estimation, the trained model may be used. The depth value on the object may correspond to a distance between a subject represented by the object and a lens of a camera used to obtain an image including the object. For example, the depth value on the object may include a focal length of the camera on the object and/or a DoF of the camera on the object.

The at least one processor 210 may obtain an average value of the depth values of each of the objects 500-1, 500-2, and 500-3 included in the planar panorama image 405. The at least one processor 210 may obtain the average value of the depth values of each of the objects 500-1, 500-2, and 500-3 as a depth value of the planar panorama image 405.

The at least one processor 210 may determine an object (e.g., the object 500-3) from among the objects 500-1, 500-2, and 500-3 included in the planar panorama image 405 as a reference object. For example, the object (e.g., the object 500-3) may be determined as the reference object as a reference condition is satisfied. The reference condition may be preset or may be set (or changed) by a user. The at least one processor 210 may obtain the depth value on the object (e.g., the object 500-3) determined as the reference object as the depth value of the planar panorama image 405.

The at least one processor 210 may identify a region of interest (ROI) in the planar panorama image 405. The at least one processor 210 may identify at least one object (e.g., the object 500-3) included in the ROI from among the objects 500-1, 500-2, and 500-3. The at least one processor 210 may obtain a depth value on at least one object (e.g., the object 500-3) included in the ROI as a depth value of the planar panorama image 405. However, it is not limited thereto.

Referring back to FIG. 3, in operation 330, the at least one processor 210 may obtain a curvature for generating a cylindrical panorama image, using a depth value of a planar panorama image. The curvature for generating the cylindrical panorama image may indicate the degree to which the planar panorama image is bent to convert the planar panorama image to the cylindrical panorama image. For example, the curvature for generating the cylindrical panorama image may be represented as a real number between 0 and 1.

The curvature for generating the cylindrical panorama image may be obtained in accordance with Equation 1 below. The curvature for generating the cylindrical panorama image may be obtained by applying the depth value of the planar panorama image to Equation 1 below.

$$curvature = 1 - \frac{DoF - {DoF}_{min}}{{DoF}_{max} - {DoF}_{min}} \qquad Equation 1$$

Equation 1 is only an example for helping understanding, and an embodiment of the disclosure may not be limited thereto. Equation 1 may be modified, applied, or extended in various ways.

In Equation 1, curvature may indicate the curvature for generating the cylindrical panorama image, depth of field (or depth of focus) (DoF) may indicate the depth value of the planar panorama image, DoFₘᵢₙ may indicate a minimum value of the depth value of the planar panorama image, and DoFₘₐₓ may indicate a maximum value of the depth value of the planar panorama image. The DoFₘᵢₙ and the DoFₘₐₓ may be described as constants. The DoFₘᵢₙ may be set based on the minimum value of the depth value (or the minimum value of the depth map) obtainable from the planar panorama image. The DoFₘₐₓ may be set based on an infinite value of the depth value (or the maximum value of the depth map) obtainable from the planar panorama image. The curvature for generating the cylindrical panorama image may be inversely proportional to the depth value of the planar panorama image. For example, the curvature for generating the cylindrical panorama image may be 0 when the depth value of the planar panorama image is at the maximum value (e.g., the DoFₘₐₓ) and 1 when the depth value of the planar panorama image is at the minimum value (e.g., the DoFₘᵢₙ). The curvature for generating the cylindrical panorama image may be represented as a real number between 0 and 1.

In operation 340, the at least one processor 210 may generate the cylindrical panorama image in accordance with the curvature, using the planar panorama image. In order to generate the cylindrical panorama image in accordance with the curvature, the curvature may be applied as a weight to each of a plane vector and a cylinder vector. For example, the plane vector may be described as a vector value of the planar panorama image in a three dimensional (3D) space. For example, the cylinder vector may be described as a vector value of the planar panorama image projected on a cylinder mesh in the 3D space. The cylinder mesh may be described as a mesh in which the planar panorama image is to be projected to generate the cylindrical panorama image having a maximum curvature (e.g., 1). The planar panorama image projected on the cylinder mesh may be described as the cylindrical panorama image in accordance with the maximum curvature. The plane vector and the cylinder vector may be obtained in accordance with the following Equations (e.g., Equations 2 to 7).

$$radius = \frac{1}{tan ( 0.5 * vertical FOV * \frac{π}{180} )} \qquad Equation 2$$

Equation 2 is only an example for helping understanding, and an embodiment of the disclosure may not be limited thereto. Equation 2 may be modified, applied, or extended in various ways.

In Equation 2, radius may indicate a radius value of the cylinder mesh, and vertical FOV may indicate a vertical FOV value of the planar panorama image. The vertical FOV value of the planar panorama image may be determined in accordance with a height value of the planar panorama image and a depth value of the planar panorama image. The radius value of the cylinder mesh may be obtained by applying the vertical FOV value of the planar panorama image to Equation 2.

$$horizontal FOV = vertical FOV * \frac{image width}{image height} \qquad Equation 3$$

Equation 3 is only an example for helping understanding, and an embodiment of the disclosure may not be limited thereto. Equation 3 may be modified, applied, or extended in various ways.

In Equation 3, horizontal FOV may indicate a horizontal FOV value of the planar panorama image, vertical FOV may indicate a vertical FOV value of the planar panorama image, image width may indicate a width value of the planar panorama image, and image height may indicate a height value of the planar panorama image. The horizontal FOV value of the planar panorama image may be obtained by applying the vertical FOV value of the planar panorama image, the width value of the planar panorama image, and the height value of the planar panorama image to Equation 3. The vertical FOV value of the planar panorama image may correspond to the vertical FOV in Equation 2.

$$texture coordinate = \{ [ \begin{matrix}tx \\ ty\end{matrix} ] \vert t x ∈ [ 0 \text{.0} , 1. ] , ty ∈ [ 0 \text{.0} , 1. ] \} \qquad Equation 4$$

Equation 4 is only an example for helping understanding, and an embodiment of the disclosure may not be limited thereto. Equation 4 may be modified, applied, or extended in various ways.

In Equation 4, texture coordinate may indicate a coordinate value of a texture on a 2D plane for projecting the planar panorama image into a 3D space, tx may indicate an x-coordinate value of the texture, and ty may indicate a y-coordinate value of the texture. The x-coordinate value of the texture may be defined as a real number between 0.0 and 1.0, and the y-coordinate value of the texture may be defined as a real number between 0.0 and 1.0. The coordinate value of the texture may be defined as a vector of the texture. The coordinate value of the texture may be defined in accordance with Equation 4.

$$Radius = [ \begin{matrix}rx \\ ry\end{matrix} ] = radians ( texture coordinates - 0.5 ) \cdot [ \begin{matrix}horizontal FOV \\ vertical FOV\end{matrix} ] \qquad Equation 5$$

Equation 5 is only an example for helping understanding, and an embodiment of the disclosure may not be limited thereto. Equation 5 may be modified, applied, or extended in various ways.

In Equation 5, Radius may indicate a coordinate value of the radius of the cylinder mesh on the 2D plane, rx may indicate an x-coordinate value of the radius of the cylinder mesh, ry may indicate a y-coordinate value of the radius of the cylinder mesh, radians may indicate a radian value of the cylinder mesh, textual coordinate may indicate a coordinate value of the texture on the 2D plane for projecting the planar panorama image into the 3D space, horizontal FOV may indicate a horizontal FOV value of the planar panorama image, and vertical FOV may indicate a vertical FOV value of the planar panorama image. The horizontal FOV value of the planar panorama image may be obtained in accordance with Equation 3. The coordinate value of the texture on the 2D plane for projecting the planar panorama image into the 3D space may be obtained in accordance with Equation 4. The coordinate value of the radius of the cylinder mesh may be defined as a vector of the radius of the cylinder mesh. The radian value of the cylinder mesh may be determined in accordance with the radius value of the cylinder mesh. The radius value of the cylinder mesh may be obtained in accordance with Equation 2. The coordinate value of the radius of the cylinder mesh may be defined in accordance with Equation 5.

$$cylinder vector = [ \begin{matrix}x \\ y \\ z\end{matrix} ] = [ \begin{matrix}radius \cdot sin ( rx ) ] \\ 2 ty - 1 \\ - radius \cdot cos ( rx )\end{matrix} ] \qquad Equation 6$$

Equation 6 is only an example for helping understanding, and an embodiment of the disclosure may not be limited thereto. Equation 6 may be modified, applied, or extended in various ways.

In Equation 6, cylinder vector may indicate a coordinate value of the planar panorama image projected on the cylinder mesh in the 3D space, x may indicate an x-coordinate value of the planar panorama image projected on the cylinder mesh in the 3D space, y may indicate a y-coordinate value of the planar panorama image projected on the cylinder mesh in the 3D space, z may indicate a z-coordinate value of the planar panorama image projected on the cylinder mesh in the 3D space, radius may indicate a radius value of the cylinder mesh, rx may indicate an x-coordinate value of the radius of the cylinder mesh, and ty may indicate a y-coordinate value of the texture. The radius value of the cylinder mesh may be obtained in accordance with Equation 2. The y-coordinate value of the texture may be obtained in accordance with Equation 4. The x-coordinate value of the radius of the cylinder mesh may be obtained in accordance with Equation 5. The coordinate value of the planar panorama image projected on the cylinder mesh in the 3D space may be defined as a vector in the 3D space. An equation obtained by Equation 6 may indicate the planar panorama image projected on the cylinder mesh in in the 3D space.

$$plane vector = [ \begin{matrix}x \\ y \\ z\end{matrix} ] = [ \begin{matrix}rx \cdot radius \\ 2 ty - 1 \\ - radius\end{matrix} ] \qquad Equation 7$$

Equation 7 is only an example for helping understanding, and an embodiment of the disclosure may not be limited thereto. Equation 7 may be modified, applied, or extended in various ways.

In Equation 7, plane vector may indicate a coordinate value of the planar panorama image in the 3D space, x may indicate an x-coordinate value of the planar panorama image in the 3D space, y may indicate a y-coordinate value of the planar panorama image in the 3D space, z may indicate a z-coordinate value of the planar panorama image in the 3D space, radius may indicate a radius value of the cylinder mesh, rx may indicate an x-coordinate value of the radius of the cylinder mesh, and ty may indicate a y-coordinate value of the texture. The radius value of the cylinder mesh may be obtained in accordance with Equation 2. The y-coordinate value of the texture may be obtained in accordance with Equation 4. The x-coordinate value of the radius of the cylinder mesh may be obtained in accordance with Equation 5. The coordinate value of the planar panorama image in the 3D space may be defined as a vector in the 3D space. An equation obtained by Equation 7 may indicate the planar panorama image in the 3D space.

$$projection xyz = ( 1 - curvature ) \cdot plane vector + curvature \cdot cylinder vector \qquad Equation 8$$

Equation 8 is only an example for helping understanding, and an embodiment of the disclosure may not be limited thereto. Equation 8 may be modified, applied, or extended in various ways.

In Equation 8, projection xyz may indicate a coordinate value of the cylindrical panorama image in accordance with a curvature in the 3D space, curvature may indicate a curvature for generating the cylindrical panorama image, plane vector may indicate a coordinate value of the planar panorama image in the 3D space, and cylinder vector may indicate a coordinate value of the planar panorama image projected on the cylinder mesh in the 3D space. The curvature of the cylindrical panorama image may correspond to the curvature for generating the cylindrical panorama image. The curvature for generating the cylindrical panorama image may be obtained in accordance with Equation 1. The coordinate value of the planar panorama image in the 3D space may be obtained in accordance with Equation 7. The coordinate value of the cylindrical panorama image in accordance with the curvature in the 3D space may be obtained according to Equation 8.

The coordinate value of the cylindrical panorama image in accordance with the curvature in the 3D space may be obtained by applying a first weight to the coordinate value of the planar panorama image in the 3D space and applying a second weight to the coordinate value of the planar panorama image projected on the cylinder mesh in the 3D space. The at least one processor 210 may perform linear interpolation (LERP) between the coordinate value of the planar panorama image in the 3D space and the coordinate value of the planar panorama image projected on the cylinder mesh in the 3D space, by applying the first weight to the coordinate value of the planar panorama image in the 3D space, and by applying the second weight to the coordinate value of the planar panorama image projected on the cylinder mesh in the 3D space. The first weight and the second weight may be determined in accordance with the curvature for generating a cylindrical panorama image. The first weight (e.g., 1—the curvature for generating the cylindrical panorama image) may be inversely proportional to the curvature, and the second weight (e.g., the curvature for generating the cylindrical panorama image) may be proportional to the curvature. The at least one processor 210 may generate the cylindrical panorama image in accordance with the curvature in accordance with Equation 8.

The at least one processor 210 may obtain the curvature for generating a spheral panorama image, using the depth value of the planar panorama image. The at least one processor 210 may generate the spheral panorama image in accordance with the curvature, using the planar panorama image. In order to generate the spheral panorama image, the plane vector and a sphere vector may be used. The at least one processor 210 may perform the linear interpolation, by applying the curvature as a weight to each of the plane vector and the sphere vector. The at least one processor 210 may apply the first weight to the plane vector and apply the second weight to the sphere vector. The first weight and the second weight may be determined in accordance with the curvature for generating the spheral panorama image. The first weight (e.g., 1—the curvature for generating the spheral panorama image) may be inversely proportional to the curvature, and the second weight (e.g., the curvature for generating the spheral panorama image) may be proportional to the curvature.

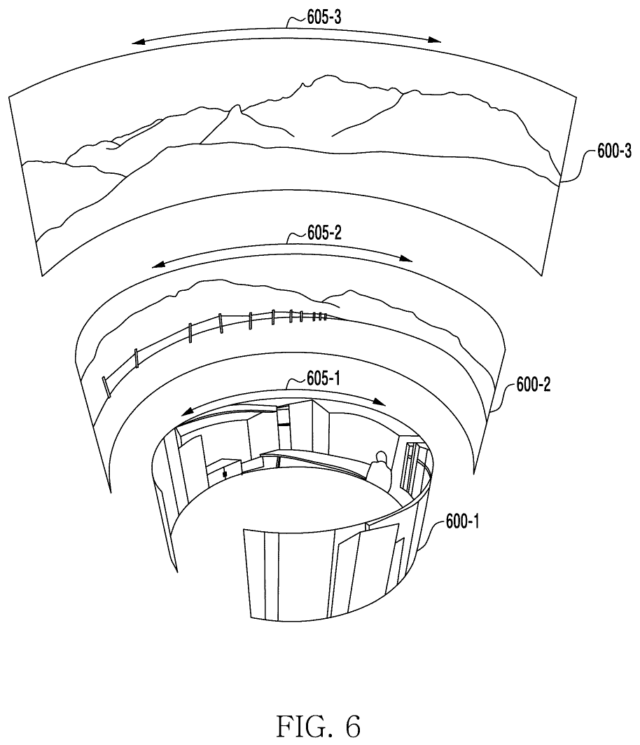

The cylindrical panorama image may be generated differently in accordance with the curvature. The cylindrical panorama images having different curvatures will be exemplified in a description of FIG. 6.

FIG. 6 illustrates an example of cylindrical panorama images having different curvatures according to an embodiment of the disclosure.

Referring to FIG. 6, a first cylindrical panorama image 600-1, a second cylindrical panorama image 600-2, and a third cylindrical panorama image 600-3 may be described as a cylindrical panorama image generated using a planar panorama image. A first depth value of a first planar panorama image used to generate the first cylindrical panorama image 600-1 may be smaller than a second depth value of a second planar panorama image used to generate the second cylindrical panorama image 600-2. The second depth value of the second planar panorama image used to generate the second cylindrical panorama image 600-2 may be smaller than a third depth value of a third planar panorama image used to generate the third cylindrical panorama image 600-3.

The cylindrical panorama image generated by applying different curvatures to the planar panorama image may be generated to have cylindrical shapes with different curvatures. For example, the at least one processor 210 may compensate (or reduce) distortions caused in the planar panorama image in accordance with an environment in which the planar panorama image is shot, a focal length of a camera shooting the planar panorama image, and a depth value of the planar panorama image, by generating the cylindrical panorama image, using the planar panorama image.

Since the curvature for generating the cylindrical panorama image is inversely proportional to the depth value of the planar panorama image used to generate the cylindrical panorama image, a first curvature 605-1 of the first cylindrical panorama image 600-1 may be larger than a second curvature 605-2 of the second cylindrical panorama image 600-2, and the second curvature 605-2 of the second cylindrical panorama image 600-2 may be larger than a the third curvature 605-3 of the third cylindrical panorama image 600-3. The first curvature 605-1 of the first cylindrical panorama image 600-1 may be larger than the third curvature 605-3 of the third cylindrical panorama image 600-3.

Since the first curvature 605-1 is larger than the second curvature 605-2, the first cylindrical panorama image 600-1 may be further curved or bent than the second cylindrical panorama image 600-2. Since the second curvature 605-2 is larger than the third curvature 605-3, the second cylindrical panorama image 600-2 may be further curved or bent than the third cylindrical panorama image 600-3.

As the depth value of the planar panorama image increases, low distortion may occur (or be caused) in the planar panorama image. Since the second depth value of the second planar panorama image is larger than the first depth value of the first planar panorama image, even if the second curvature 605-2 of the second cylindrical panorama image 600-2 is smaller than the first curvature 605-1 of the first cylindrical panorama image 600-1, the low distortion may occur (or be caused) in the second cylindrical panorama image 600-2. Since the third depth value of the third planar panorama image is larger than the second depth value of the second planar panorama image, even if the third curvature 605-3 of the third cylindrical panorama image 600-3 is smaller than the second curvature 605-2 of the second cylindrical panorama image 600-2, the low distortion may occur (or be caused) in the third cylindrical panorama image 600-3.

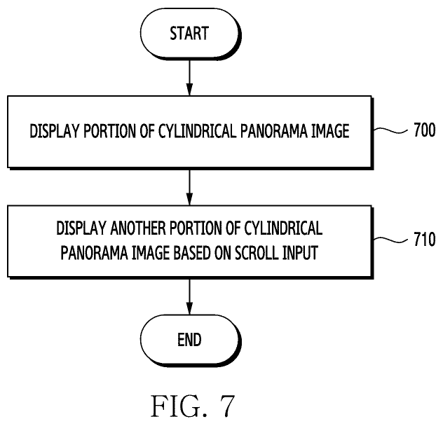

The at least one processor 210 may display, via the display 230, a portion of the cylindrical panorama image (e.g., the first cylindrical panorama image 600-1, the second cylindrical panorama image 600-2, or the third cylindrical panorama image 600-3). Displaying a portion of the cylindrical panorama image will be illustrated in a description of FIG. 7.

FIG. 7 is a flowchart illustrating operations of an electronic device for displaying a portion of a cylindrical panorama image according to an embodiment of the disclosure.

Referring to FIG. 7, in operation 700, the at least one processor 210 may display, via the display 230, a portion of the cylindrical panorama image. For example, the portion of the cylindrical panorama image may be described as a portion of the cylindrical panorama image displayed via the display 230 when a height of the cylindrical panorama image corresponds (or substantially corresponds) to a height of a display area of the display 230. The at least one processor 210 may determine the portion of the cylindrical panorama image by matching the height of the cylindrical panorama image to the height of the display area of the display 230. The portion of the cylindrical panorama image may be viewed at a position where the cylindrical panorama image is separated from the cylindrical panorama image by a reference distance. For example, the reference distance may be determined in accordance with a vertical FOV of the planar panorama image. The reference distance may correspond to a radius of a cylinder mesh on which the planar panorama image is projected. For example, the radius of the cylinder mesh on which the planar panorama image is projected may be determined in accordance with the reference distance.

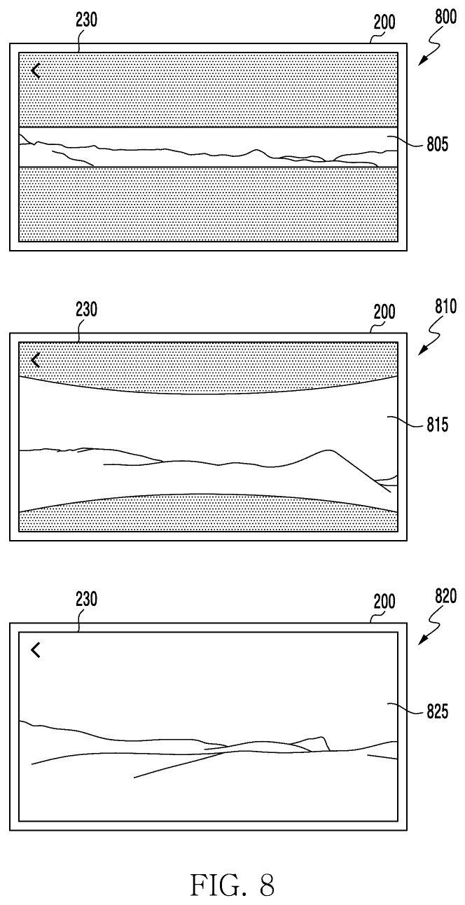

The at least one processor 210 may display an animation changed from the planar panorama image to the cylindrical panorama image via the display 230 before displaying the portion of the cylindrical panorama image. The at least one processor 210 may display the portion of the cylindrical panorama image, based on the animation changed from the planar panorama image to the cylindrical panorama image being terminated. The animation changed from the planar panorama image to the cylindrical panorama image will be illustrated in a description of FIG. 8.

FIG. 8 illustrates an example of an animation changed from a planar panorama image to a cylindrical panorama image according to an embodiment of the disclosure.

Referring to FIG. 8, a state 800 may be described as a state in which a planar panorama image 805 is displayed. In the state 800, the at least one processor 210 may receive a user input (e.g., the user input 415 of FIG. 4) for displaying a cylindrical panorama image while displaying the planar panorama image 805 via a display 230. It is possible to switch from the state 800 to a state 810 based on the user input.

In the state 810, the at least one processor 210 may display an animation 815 changed from the planar panorama image 805 to the cylindrical panorama image via the display 230. The cylindrical panorama image may be described as a panorama image generated using the planar panorama image 805. As the planar panorama image 805 is changed from the planar panorama image 805 to the cylindrical panorama image in the animation 815, the planar panorama image 805 may be extended to an area where the planar panorama image 805 is not displayed (or a blank area or a letter box area). As the planar panorama image 805 is changed from the planar panorama image 805 to the cylindrical panorama image in the animation 815, the planar panorama image 805 may have a curvature. As the planar panorama image 805 is changed from the planar panorama image 805 to the cylindrical panorama image in the animation 815, the planar panorama image 805 may be bent or curved. Based on the animation 815 being terminated, an electronic device 200 may switch from the state 810 to a state 820.

In the state 820, the at least one processor 210 may identify that the animation 815 is terminated. The at least one processor 210 may display, via the display 230, a portion 825 of the cylindrical panorama image, based on identifying that the animation 815 is terminated. The at least one processor 210 may notify that the portion 825 of the cylindrical panorama image is displayed in the state 820, by displaying the animation 815 converted from the planar panorama image 805 to the cylindrical panorama image. A user who is aware that the portion 825 of the cylindrical panorama image is displayed may perform a scroll input to view another portion of the cylindrical panorama image.

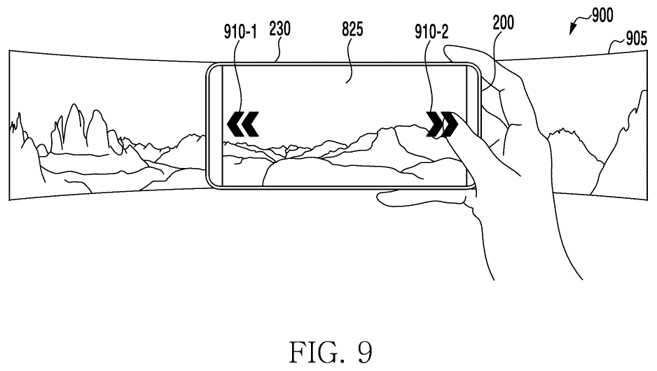

Referring back to FIG. 7, in operation 710, the at least one processor 210 may receive, via the display 230, the scroll input while displaying a portion of the cylindrical panorama image. The at least one processor 210 may display the another portion of the cylindrical panorama image by scrolling the cylindrical panorama image, based on the scroll input. Scrolling the cylindrical panorama image will be exemplified in a description of FIG. 9.

FIG. 9 illustrates an example of scrolling a cylindrical panorama image according to an embodiment of the disclosure.

Referring to FIG. 9, a state 900 may be described as a state in which a portion 825 of a cylindrical panorama image 905 is displayed. In the state 900, the at least one processor 210 may display, via the display 230, UI 910-1 and 910-2 for a scroll input together with the portion 825 of the cylindrical panorama image 905 (or on the portion 825 of the cylindrical panorama image 905). For example, the UI 910-1 and 910-2 may indicate a direction in which the cylindrical panorama image 905 may be scrolled. For example, the UI 910-1 may indicate a first direction (e.g., left), and the UI 910-2 may indicate a second direction (e.g., right). The at least one processor 210 may notify a direction in which the cylindrical panorama image 905 may be scrolled, by displaying the UI 910-1 and 910-2.

The at least one processor 210 may receive the scroll input while the portion 825 of the cylindrical panorama image 905 is displayed. For example, the scroll input may include a sequence of touch inputs. The sequence of the touch inputs may include a touch input having a contact point on the portion 825 of the cylindrical panorama image 905, a drag input (or a swipe input, or a sweeping input or a fling input), in which the touch input is moved, and an input released after the touch input is moved. The scroll input may be received via the display 230 (e.g., a touch screen). For example, the scroll input may be received via an external electronic device (e.g., a mouse) connected to an electronic device 200. For example, the scroll input may include a user input (e.g., a mouse wheel scroll input) received via the external electronic device (e.g., the mouse).

The scroll input may include an input changing a posture (or an orientation) of the electronic device 200. The electronic device 200 may further include at least one sensor configured to obtain sensing values in accordance with a change of the posture of the electronic device 200. The at least one sensor may include a gesture sensor, a gyro sensor, or an acceleration sensor. The at least one processor 210 may obtain the sensing values via the at least one sensor while displaying the portion 825 of the cylindrical panorama image 905. For example, the sensing values may be different in accordance with the posture (or the orientation) of the electronic device 200. As the posture (or the orientation) of the electronic device 200 is changed, a sensing value obtained via the at least one sensor may be changed. The at least one processor 210 may receive the scroll input in accordance with the change in the posture (or the orientation) of the electronic device 200, based on identifying a change in the sensing values obtained while displaying the portion 825 of the cylindrical panorama image 905.

The at least one processor 210 may scroll the cylindrical panorama image 905, based on the scroll input. The cylindrical panorama image 905 may be scrolled in a direction indicated by the scroll input. For example, the direction indicated by the scroll input may include a direction of the drag input (or the swipe input, the sweeping input, or the fling input). For example, the direction indicated by the scroll input may include a direction in which the posture (or the orientation) of the electronic device 200 is changed. However, embodiments of the disclosure are not limited thereto. The at least one processor 210 may display another portion of the cylindrical panorama image 905 via the display 230 by scrolling the cylindrical panorama image 905.

The sensing values in accordance with the change in the posture of the electronic device 200 may be mapped to each of the portions of the cylindrical panorama image 905. For example, a planar panorama image used to generate the cylindrical panorama image 905 may be obtained by the electronic device 200 (or the external electronic device) including the at least one sensor. The electronic device 200 (or the external electronic device) including the at least one sensor may shoot (or obtain) a plurality of images to obtain the planar panorama image. For example, the at least one sensor may include the gyro sensor. The electronic device 200 (or the external electronic device) including the at least one sensor may store the sensing values obtained via the at least one sensor in association with the plurality of images while shooting the plurality of images. The electronic device 200 (or the external electronic device) including the at least one sensor may obtain the planar panorama image by coupling the plurality of images. The at least one processor 210 may obtain the sensing value via the at least one sensor while displaying the portion 825 of the cylindrical panorama image 905. The at least one processor 210 may identify the another portion of the cylindrical panorama image 905 corresponding to the sensing value obtained while displaying the portion 825 of the cylindrical panorama image 905. The at least one processor 210 may display, via the display 230, the another portion of the cylindrical panorama image 905 corresponding to the sensing value.

The at least one processor 210 may provide the cylindrical panorama image 905 by displaying each of the portions of the cylindrical panorama image 905 via the display 230. An object included in the cylindrical panorama image 905 may be less curved or bent than an object included in the planar panorama image. The cylindrical panorama image 905 may include a relatively low (or reduced) distortion than the planar panorama image. The at least one processor 210 may provide the cylindrical panorama image 905 with reduced distortion by displaying each of the portions of the cylindrical panorama image 905.

The at least one processor 210 may receive an input for extending (or reducing) the portion 825 of the cylindrical panorama image 905 while the portion 825 of the cylindrical panorama image 905 is displayed. The at least one processor 210 may display the another portion of the cylindrical panorama image 905 via the display 230 by extending (or reducing) the portion 825 of the cylindrical panorama image 905, based on the input for extending (or reducing) the portion 825 of the cylindrical panorama image 905.

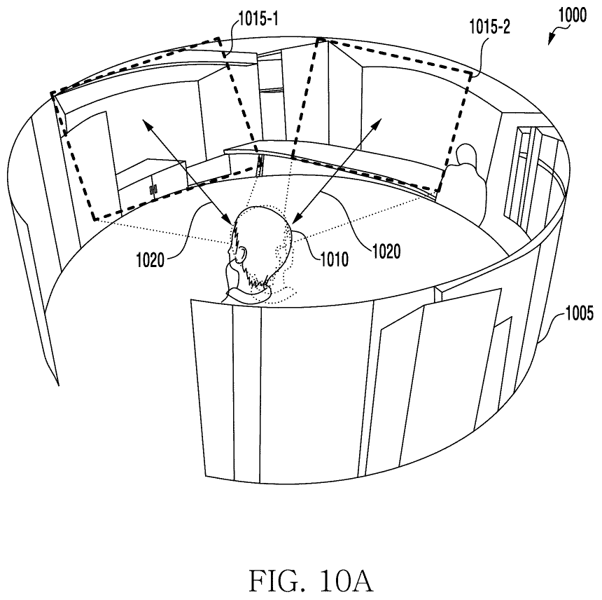

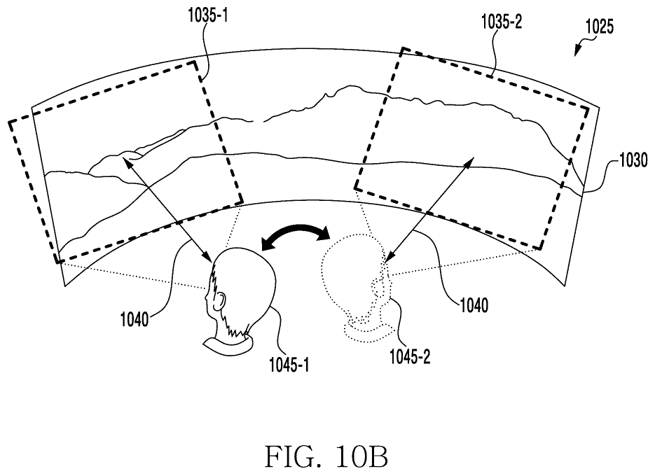

The portion 825 of the cylindrical panorama image 905 may be displayed to be viewed at a position separated from the portion 825 of the cylindrical panorama image 905 by a reference distance. The another portion of the cylindrical panorama image 905 may be displayed to be viewed at a position separated from the another portion of the cylindrical panorama image 905 by the reference distance. The position separated from the portion 825 of the cylindrical panorama image 905 by the reference distance may be different from the position separated from the another portion of the cylindrical panorama image 905 by the reference distance, or may correspond to the position separated from the another portion of the cylindrical panorama image 905 by the reference distance. Whether the position separated from the portion 825 of the cylindrical panorama image 905 by the reference distance corresponds to the position separated from the another portion of the cylindrical panorama image 905 by the reference distance may vary in accordance with a curvature of the cylindrical panorama image 905. A position separated from a cylindrical panorama image by a reference distance will be exemplified in a description of FIGS. 10A and 10B.

FIGS. 10A and 10B illustrate an example of displaying a portion of a cylindrical panorama image to be viewed at a position separated from the cylindrical panorama image by a reference distance according to various embodiments of the disclosure.

Referring to FIG. 10A, a state 1000 may be described as a state in which a first cylindrical panorama image 1005 in accordance with a first curvature is viewed. The first curvature may be described as a relatively large curvature. The first curvature may correspond to or substantially correspond to a maximum curvature (e.g., 1). In the state 1000, a first portion 1015-1 of the first cylindrical panorama image 1005 may be displayed to be viewed on a position 1010 separated from the first portion 1015-1 of the first cylindrical panorama image 1005 by a first reference distance 1020, and a second portion 1015-2 of the first cylindrical panorama image 1005 may be displayed to be viewed on the position 1010 separated from the second portion 1015-2 of the first cylindrical panorama image 1005 by the first reference distance 1020.

The first reference distance 1020 may be described as a radius of the cylinder mesh used to generate the first cylindrical panorama image 1005. Since the first curvature of the first cylindrical panorama image 1005 corresponds to or substantially corresponds to the maximum curvature, the first curvature of the first cylindrical panorama image 1005 may correspond to or substantially correspond to a curvature of the cylinder mesh used to generate the first cylindrical panorama image 1005. Since the first curvature of the first cylindrical panorama image 1005 corresponds to or substantially corresponds to the curvature of the cylinder mesh used to generate the first cylindrical panorama image 1005, and the first reference distance 1020 is the radius of the cylinder mesh used to generate the first cylindrical panorama image 1005, the position 1010 separated from the first portion 1015-1 of the first cylindrical panorama image 1005 by the first reference distance 1020 may correspond to or substantially correspond to the position 1010 separated from the second portion 1015-2 of the first cylindrical panorama image 1005 by the first reference distance 1020. For example, portions of the first cylindrical panorama image 1005 (e.g., the first portion 1015-1 of the first cylindrical panorama image 1005 and the second portion 1015-2 of the first cylindrical panorama image 1005) may be displayed as viewed from a center point of the cylinder mesh.

Referring to FIG. 10B, a state 1025 may be described as a state in which a second cylindrical panorama image 1030 is viewed in accordance with a second curvature. The second curvature may be described as a relatively small curvature. The second curvature may be smaller than the first curvature. In the state 1025, a first portion 1035-1 of the second cylindrical panorama image 1030 may be displayed to be viewed on a position 1045-1 separated from the first portion 1035-1 of the second cylindrical panorama image 1030 by a second reference distance 1040, and a second portion 1035-2 of the second cylindrical panorama image 1030 may be displayed to be viewed on a position 1045-2 separated from the second portion 1035-2 of the second cylindrical panorama image 1030 by the second reference distance 1040.

The second reference distance 1040 may be described by a radius of the cylinder mesh used to generate the second cylindrical panorama image 1030. Since the second curvature of the second cylindrical panorama image 1030 is smaller than the first curvature, the second curvature of the second cylindrical panorama image 1030 may be smaller than a curvature (e.g., 1) of the cylinder mesh used to generate the second cylindrical panorama image 1030. Since the second curvature of the second cylindrical panorama image 1030 is smaller than the curvature of the cylinder mesh used to generate the second cylindrical panorama image 1030, and the second reference distance 1040 is the radius of the cylinder mesh used to generate the second cylindrical panorama image 1030, the position 1045-1 separated from the first portion 1035-1 of the second cylindrical panorama image 1030 by the second reference distance 1040 may be different from the position 1045-2 separated from the second portion 1035-2 of the second cylindrical panorama image 1030 by the second reference distance 1040.

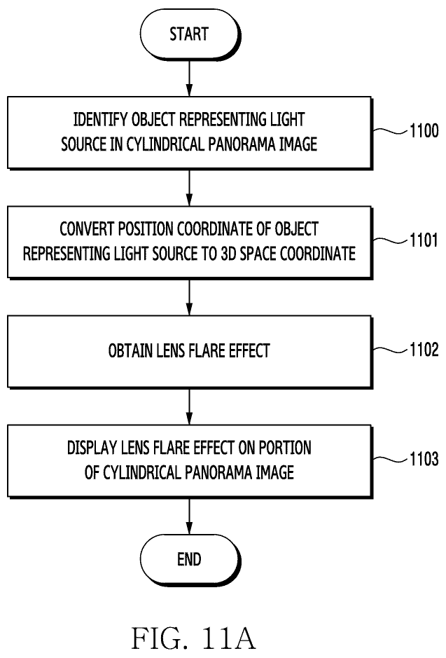

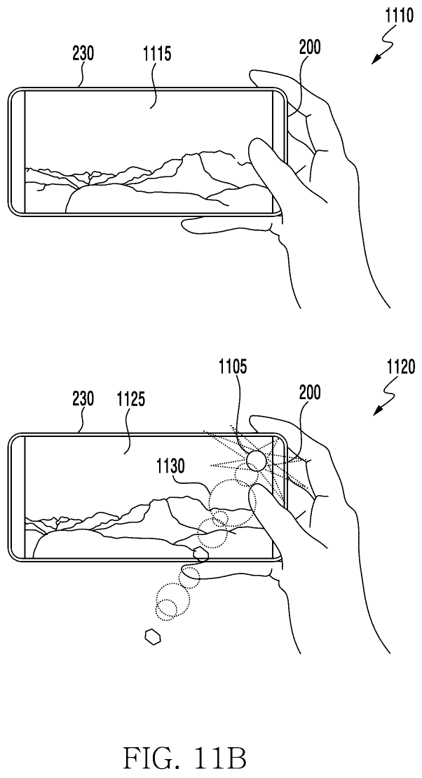

FIG. 11A is a flowchart illustrating operations of an electronic device for displaying a lens flare effect on a portion of a cylindrical panorama image according to an embodiment of the disclosure.

Referring to FIG. 11A, in operation 1100, at least one processor 210 may identify an object representing a light source in a cylindrical panorama image. The at least one processor 210 may perform object detection on the cylindrical panorama image to identify the object representing the light source in the cylindrical panorama image. The at least one processor 210 may identify objects included in the cylindrical panorama image by performing the object detection on the cylindrical panorama image. For example, the at least one processor 210 may perform object classification on the detected objects. For example, the object detection and the object classification may be performed using a trained model. By performing the object classification, the at least one processor 210 may identify the object representing the light source in the cylindrical panorama image from among objects included in the cylindrical panorama image.

In operation 1101, the at least one processor 210 may convert a position coordinate of the object representing the light source to a coordinate in a three dimensional (3D) space, based on identifying an object 1105 representing the light source in the cylindrical panorama image. For example, the coordinate of the object representing the light source in the 3D space may be described as a coordinate on a central axis of a cylinder mesh used to generate the cylindrical panorama image.

In operation 1102, the at least one processor 210 may obtain a lens flare effect, using the coordinate of the object representing the light source in the 3D space. The lens flare effect may be described as an artifact in an image generated by light from the light source being scattered by a lens system of a camera when the image is obtained via the camera. The at least one processor 210 may display, via a display 230, a portion of the cylindrical panorama image including the object representing the light source. For example, the lens flare effect may differ in accordance with a position of the object representing the light source in the portion of the cylindrical panorama image.

In operation 1103, the at least one processor 210 may display the obtained lens flare effect in the portion of the cylindrical panorama image. For example, the lens flare effect may be displayed as associated with the object representing the light source in the cylindrical panorama image. The lens flare effect displayed in the portion of the cylindrical panorama image is illustrated in a description of FIG. 11B.

FIG. 11B illustrates an example of a lens flare effect displayed in a portion of a cylindrical panorama image according to an embodiment of the disclosure.

Referring to FIG. 11B, in a state 1110, the at least one processor 210 may display, via the display 230, a first portion 1115 of a cylindrical panorama image. For example, an object 1105 representing a light source may not be included in the first portion 1115 of the cylindrical panorama image. The at least one processor 210 may identify whether the object 1105 representing the light source is included in the first portion 1115 of the cylindrical panorama image. Based on identifying that the object 1105 representing the light source is not included in the first portion 1115 of the cylindrical panorama image, the at least one processor 210 may refrain from (or stop, skip, or not display) displaying a lens flare effect on the first portion 1115 of the cylindrical panorama image.

In a state 1120, the at least one processor 210 may display, via the display 230, a second portion 1125 of the cylindrical panorama image. For example, the object 1105 representing the light source may be included in the second portion 1125 of the cylindrical panorama image. The at least one processor 210 may identify a position of the object 1105 representing the light source in the second portion 1125 of the cylindrical panorama image to obtain a lens flare effect 1130. The lens flare effect 1130 may be described as an artifact in an image generated by the light from the light source being scattered by a lens system of a camera when the image is obtained via the camera. The lens flare effect 1130 may be displayed differently in accordance with a position of the light source. The at least one processor 210 may obtain the lens flare effect 1130, based on the position of the object 1105 representing the light source in the second portion 1125 of the cylindrical panorama image and a 3D space coordinate of the light source represented by the object 1105. The at least one processor 210 may display the lens flare effect 1130 on the second portion 1125 of the cylindrical panorama image. For example, the lens flare effect 1130 may be displayed as associated with the object 1105. By displaying the lens flare effect 1130 on the second portion 1125 of the cylindrical panorama image, the second portion 1125 of the cylindrical panorama image may be viewed as being shot on a position separated from the second portion 1125 of the cylindrical panorama image by a reference distance.

FIG. 12 is a block diagram illustrating an electronic device in a network environment according to an embodiment of the disclosure.

Referring to FIG. 12, the electronic device 1201 in the network environment 1200 may communicate with an electronic device 1202 via a first network 1298 (e.g., a short-range wireless communication network), or at least one of an electronic device 1204 or a server 1208 via a second network 1299 (e.g., a long-range wireless communication network). According to an embodiment, the electronic device 1201 may communicate with the electronic device 1204 via the server 1208. According to an embodiment, the electronic device 1201 may include a processor 1220, memory 1230, an input module 1250, a sound output module 1255, a display module 1260, an audio module 1270, a sensor module 1276, an interface 1277, a connecting terminal 1278, a haptic module 1279, a camera module 1280, a power management module 1288, a battery 1289, a communication module 1290, a subscriber identification module (SIM) 1296, or an antenna module 1297. In some embodiments, at least one of the components (e.g., the connecting terminal 1278) may be omitted from the electronic device 1201, or one or more other components may be added in the electronic device 1201. In some embodiments, some of the components (e.g., the sensor module 1276, the camera module 1280, or the antenna module 1297) may be implemented as a single component (e.g., the display module 1260).

The processor 1220 may execute, for example, software (e.g., a program 1240) to control at least one other component (e.g., a hardware or software component) of the electronic device 1201 coupled with the processor 1220, and may perform various data processing or computation. According to an embodiment, as at least part of the data processing or computation, the processor 1220 may store a command or data received from another component (e.g., the sensor module 1276 or the communication module 1290) in volatile memory 1232, process the command or the data stored in the volatile memory 1232, and store resulting data in non-volatile memory 1234. According to an embodiment, the processor 1220 may include a main processor 1221 (e.g., a central processing unit (CPU) or an application processor (AP)), or an auxiliary processor 1223 (e.g., a graphics processing unit (GPU), a neural processing unit (NPU), an image signal processor (ISP), a sensor hub processor, or a communication processor (CP)) that is operable independently from, or in conjunction with, the main processor 1221. For example, when the electronic device 1201 includes the main processor 1221 and the auxiliary processor 1223, the auxiliary processor 1223 may be adapted to consume less power than the main processor 1221, or to be specific to a specified function. The auxiliary processor 1223 may be implemented as separate from, or as part of the main processor 1221.

The auxiliary processor 1223 may control at least some of functions or states related to at least one component (e.g., the display module 1260, the sensor module 1276, or the communication module 1290) among the components of the electronic device 1201, instead of the main processor 1221 while the main processor 1221 is in an inactive (e.g., sleep) state, or together with the main processor 1221 while the main processor 1221 is in an active state (e.g., executing an application). According to an embodiment, the auxiliary processor 1223 (e.g., an image signal processor or a communication processor) may be implemented as part of another component (e.g., the camera module 1280 or the communication module 1290) functionally related to the auxiliary processor 1223. According to an embodiment, the auxiliary processor 1223 (e.g., the neural processing unit) may include a hardware structure specified for artificial intelligence model processing. An artificial intelligence model may be generated by machine learning. Such learning may be performed, e.g., by the electronic device 1201 where the artificial intelligence is performed or via a separate server (e.g., the server 1208). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 1230 may store various data used by at least one component (e.g., the processor 1220 or the sensor module 1276) of the electronic device 1201. The various data may include, for example, software (e.g., the program 1240) and input data or output data for a command related thereto. The memory 1230 may include the volatile memory 1232 or the non-volatile memory 1234.

The program 1240 may be stored in the memory 1230 as software, and may include, for example, an operating system (OS) 1242, middleware 1244, or an application 1246.

The input module 1250 may receive a command or data to be used by another component (e.g., the processor 1220) of the electronic device 1201, from the outside (e.g., a user) of the electronic device 1201. The input module 1250 may include, for example, a microphone, a mouse, a keyboard, a key (e.g., a button), or a digital pen (e.g., a stylus pen).

The sound output module 1255 may output sound signals to the outside of the electronic device 1201. The sound output module 1255 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 1260 may visually provide information to the outside (e.g., a user) of the electronic device 1201. The display module 1260 may include, for example, a display, a hologram device, or a projector and control circuitry to control a corresponding one of the display, hologram device, and projector. According to an embodiment, the display module 1260 may include a touch sensor adapted to detect a touch, or a pressure sensor adapted to measure the intensity of force incurred by the touch.

The audio module 1270 may convert a sound into an electrical signal and vice versa. According to an embodiment, the audio module 1270 may obtain the sound via the input module 1250, or output the sound via the sound output module 1255 or a headphone of an external electronic device (e.g., an electronic device 1202) directly (e.g., wiredly) or wirelessly coupled with the electronic device 1201.

The sensor module 1276 may detect an operational state (e.g., power or temperature) of the electronic device 1201 or an environmental state (e.g., a state of a user) external to the electronic device 1201, and then generate an electrical signal or data value corresponding to the detected state. According to an embodiment, the sensor module 1276 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1277 may support one or more specified protocols to be used for the electronic device 1201 to be coupled with the external electronic device (e.g., the electronic device 1202) directly (e.g., wiredly) or wirelessly. According to an embodiment, the interface 1277 may include, for example, a high definition multimedia interface (HDMI), a universal serial bus (USB) interface, a secure digital (SD) card interface, or an audio interface.

A connecting terminal 1278 may include a connector via which the electronic device 1201 may be physically connected with the external electronic device (e.g., the electronic device 1202). According to an embodiment, the connecting terminal 1278 may include, for example, an HDMI connector, a USB connector, an SD card connector, or an audio connector (e.g., a headphone connector).

The haptic module 1279 may convert an electrical signal into a mechanical stimulus (e.g., a vibration or a movement) or electrical stimulus which may be recognized by a user via his tactile sensation or kinesthetic sensation. According to an embodiment, the haptic module 1279 may include, for example, a motor, a piezoelectric element, or an electric stimulator.

The camera module 1280 may capture a still image or moving images. According to an embodiment, the camera module 1280 may include one or more lenses, image sensors, image signal processors, or flashes.

The power management module 1288 may manage power supplied to the electronic device 1201. According to an embodiment, the power management module 1288 may be implemented as at least part of, for example, a power management integrated circuit (PMIC).

The battery 1289 may supply power to at least one component of the electronic device 1201. According to an embodiment, the battery 1289 may include, for example, a primary cell which is not rechargeable, a secondary cell which is rechargeable, or a fuel cell.

The communication module 1290 may support establishing a direct (e.g., wired) communication channel or a wireless communication channel between the electronic device 1201 and the external electronic device (e.g., the electronic device 1202, the electronic device 1204, or the server 1208) and performing communication via the established communication channel. The communication module 1290 may include one or more communication processors that are operable independently from the processor 1220 (e.g., the application processor (AP)) and supports a direct (e.g., wired) communication or a wireless communication. According to an embodiment, the communication module 1290 may include a wireless communication module 1292 (e.g., a cellular communication module, a short-range wireless communication module, or a global navigation satellite system (GNSS) communication module) or a wired communication module 1294 (e.g., a local area network (LAN) communication module or a power line communication (PLC) module). A corresponding one of these communication modules may communicate with the external electronic device via the first network 1298 (e.g., a short-range communication network, such as Bluetooth™, wireless-fidelity (Wi-Fi) direct, or infrared data association (IrDA)) or the second network 1299 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 1292 may identify and authenticate the electronic device 1201 in a communication network, such as the first network 1298 or the second network 1299, using subscriber information (e.g., international mobile subscriber identity (IMSI)) stored in the subscriber identification module 1296.

The wireless communication module 1292 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 1292 may support a high-frequency band (e.g., the millimeter wave (mmWave) band) to achieve, e.g., a high data transmission rate. The wireless communication module 1292 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 1292 may support various requirements specified in the electronic device 1201, an external electronic device (e.g., the electronic device 1204), or a network system (e.g., the second network 1299). According to an embodiment, the wireless communication module 1292 may support a peak data rate (e.g., 20 Gbps or more) for implementing eMBB, loss coverage (e.g., 1264 dB or less) for implementing mMTC, or U-plane latency (e.g., 0.5 ms or less for each of downlink (DL) and uplink (UL), or a round trip of 12 ms or less) for implementing URLLC.

The antenna module 1297 may transmit or receive a signal or power to or from the outside (e.g., the external electronic device) of the electronic device 1201. According to an embodiment, the antenna module 1297 may include an antenna including a radiating element composed of a conductive material or a conductive pattern formed in or on a substrate (e.g., a printed circuit board (PCB)). According to an embodiment, the antenna module 1297 may include a plurality of antennas (e.g., array antennas). In such a case, at least one antenna appropriate for a communication scheme used in the communication network, such as the first network 1298 or the second network 1299, may be selected, for example, by the communication module 1290 (e.g., the wireless communication module 1292) from the plurality of antennas. The signal or the power may then be transmitted or received between the communication module 1290 and the external electronic device via the selected at least one antenna. According to an embodiment, another component (e.g., a radio frequency integrated circuit (RFIC)) other than the radiating element may be additionally formed as part of the antenna module 1297.

According to various embodiments, the antenna module 1297 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1201 and the external electronic device 1204 via the server 1208 coupled with the second network 1299. Each of the electronic devices 1202 or 1204 may be a device of a same type as, or a different type, from the electronic device 1201. According to an embodiment, all or some of operations to be executed at the electronic device 1201 may be executed at one or more of the external electronic devices 1202, 1204, or 1208. For example, if the electronic device 1201 should perform a function or a service automatically, or in response to a request from a user or another device, the electronic device 1201, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1201. The electronic device 1201 may provide the outcome, with or without further processing of the outcome, as at least part of a reply to the request. To that end, a cloud computing, distributed computing, mobile edge computing (MEC), or client-server computing technology may be used, for example. The electronic device 1201 may provide ultra low-latency services using, e.g., distributed computing or mobile edge computing. In another embodiment, the external electronic device 1204 may include an internet-of-things (IoT) device. The server 1208 may be an intelligent server using machine learning and/or a neural network. According to an embodiment, the external electronic device 1204 or the server 1208 may be included in the second network 1299. The electronic device 1201 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 1240) including one or more instructions that are stored in a storage medium (e.g., internal memory 1236 or external memory 1238) that is readable by a machine (e.g., the electronic device 1201). For example, a processor (e.g., the processor 1220) of the machine (e.g., the electronic device 1201) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

A technical task to be achieved from the disclosure are not limited to those described above, and any other technical tasks not mentioned herein will be clearly understood by those having ordinary knowledge in the art to which the disclosure belongs.

As described above, the electronic device (e.g., the electronic device 200 of FIG. 2) may comprise at least one processor (e.g., the at least one processor 210 of FIG. 2) comprising processing circuitry, a display (e.g., the display 230 of FIG. 2), and memory (e.g., the memory 220 of FIG. 2) comprising one or more storage media storing one or more programs configured to be executed by the at least one processor individually or collectively. The one or more programs may include instructions to cause the electronic device to obtain a first panorama image (e.g., the planar panorama image 405 of FIG. 4) corresponding to a planar panorama image. The one or more programs may include instructions to cause the electronic device to detect an event to convert the first panorama image to a second panorama image. The one or more programs may include instructions to cause the electronic device to, based on the detection, obtain a depth value of the first panorama image. The one or more programs may include instructions to cause the electronic device to obtain a curvature for generating the second panorama image, based on the depth value of the first panorama image. The one or more programs may include instructions to cause the electronic device to, using the first panorama image, generate the second panorama image in accordance with the curvature. The one or more programs may include instructions to cause the electronic device to display, via the display, a portion of the second panorama image.

For example, the depth value may be obtained by identifying depth values on objects included in the first panorama image, and by obtaining an average value of the depth values as the depth value of the first panorama image.

For example, the one or more programs may include instructions to cause the electronic device to, based on the detection, determine, from among objects included in the first panorama image, a reference object. The one or more programs may include instructions to cause the electronic device to identify a depth value on the reference object. The one or more programs may include instructions to cause the electronic device to obtain the depth value on the reference object as the depth value of the first panorama image.

For example, the curvature for generating the second panorama image may be inversely proportional to the depth value of the first panorama image.

For example, the second panorama image may be generated by projecting the first panorama image on at least a portion of a cylinder mesh having a radius in accordance with the curvature.

For example, the one or more programs may include instructions to cause the electronic device to identify a vertical field of view (FOV) of the first panorama image. The one or more programs may include instructions to cause the electronic device to obtain a cylinder mesh having a radius in accordance with the vertical FOV. The one or more programs may include instructions to cause the electronic device to, based on projecting the first panorama image on a portion of the cylinder mesh, generate the second panorama image in accordance with the curvature.

For example, the one or more programs may include instructions to cause the electronic device to obtain first vector data for the first panorama image and second vector data for a second panorama image in accordance with a maximum curvature. The one or more programs may include instructions to cause the electronic device to generate the second panorama image in accordance with the curvature by applying a first weight inversely proportional to the curvature to the first vector data and applying a second weight proportional to the curvature to the second vector data.

For example, the one or more programs may include instructions to cause the electronic device to identify a vertical FOV of the first panorama image. The one or more programs may include instructions to cause the electronic device to, based on the vertical FOV, obtain a reference distance for the second panorama image. The one or more programs may include instructions to cause the electronic device to display, via the display, the portion of the second panorama image to be viewed at a position separated from the portion of the second panorama image by the reference distance.

For example, the one or more programs may include instructions to cause the electronic device to, while displaying, via the display, the first panorama image, receive a user input to display the second panorama image. The one or more programs may include instructions to cause the electronic device to, based on the user input, detect the event.

For example, the one or more programs may include instructions to cause the electronic device to display, via the display, an animation gradually changed from the first panorama image to the second panorama image. The one or more programs may include instructions to cause the electronic device to, based on identifying that the animation is terminated, display, via the display, the portion of the second panorama image.

For example, the one or more programs may include instructions to cause the electronic device to, while displaying the portion of the second panorama image, receive a scroll input. The one or more programs may include instructions to cause the electronic device to, based on the scroll input, display, via the display, another portion of the second panorama image.

For example, the one or more programs may include instructions to cause the electronic device to determine the portion of the second panorama image by matching a height of the second panorama image to a height of a display area of the display. The one or more programs may include instructions to cause the electronic device to display, via the display, the portion of the second panorama image.

For example, the electronic device may further comprise at least one sensor configured to obtain sensing values in accordance with a change of a posture of the electronic device. The one or more programs may include instructions to cause the electronic device to, while displaying the portion of the second panorama image, obtain, via the at least one sensor, a sensing value. The one or more programs may include instructions to cause the electronic device to display, via the display, another portion of the second panorama image corresponding to the sensing value.

For example, the one or more programs may include instructions to cause the electronic device to identify an object representing a light source in the second panorama image. The one or more programs may include instructions to cause the electronic device to, based on a position of the object in the portion of the second panorama image, display a lens flare effect as associated with the object on the portion of the second panorama image.

As described above, the method may be executed in an electronic device comprising a display. The method may comprise obtaining a first panorama image corresponding to a planar panorama image. The method may comprise detecting an event to convert the first panorama image to a second panorama image. The method may comprise, based on the detection, obtaining a depth value of the first panorama image. The method may comprise obtaining a curvature for generating the second panorama image, using the depth value of the first panorama image. The method may comprise, based on the first panorama image, generating the second panorama image in accordance with the curvature. The method may comprise displaying, via the display, a portion of the second panorama image.

For example, the depth value may be obtained by identifying depth values on objects included in the first panorama image, and obtaining an average value of the depth values as the depth value of the first panorama image.

For example, the method may comprise, based on the detection, determining, from among objects included in the first panorama image, a reference object. The method may comprise identifying a depth value on the reference object. The method may comprise obtaining the depth value on the reference object as the depth value of the first panorama image.

For example, the curvature for generating the second panorama image may be inversely proportional to the depth value of the first panorama image.

For example, the second panorama image may be generated by projecting the first panorama image on at least a portion of a cylinder mesh having a radius in accordance with the curvature.

For example, the method may comprise identifying a vertical field of view (FOV) of the first panorama image. The method may comprise obtaining a cylinder mesh having a radius in accordance with the vertical FOV. The method may comprise, based on projecting the first panorama image on a portion of the cylinder mesh, generating the second panorama image in accordance with the curvature.

For example, the method may comprise obtaining first vector data for the first panorama image and second vector data for a second panorama image in accordance with a maximum curvature. The method may comprise generating the second panorama image in accordance with the curvature by applying a first weight inversely proportional to the curvature to the first vector data and applying a second weight proportional to the curvature to the second vector data.

For example, the method may comprise identifying a vertical field of view (FOV) of the first panorama image. The method may comprise, based on the vertical FOV, obtaining a reference distance for the second panorama image. The method may comprise displaying, via the display, the portion of the second panorama image to be viewed at a position separated from the portion of the second panorama image by the reference distance.

For example, the method may comprise, while displaying, via the display, the first panorama image, receiving a user input to display the second panorama image. The method may comprise, based on the user input, detecting the event.

For example, the method may comprise displaying, via the display, an animation gradually changed from the first panorama image to the second panorama image. The method may comprise, based on identifying that the animation is terminated, displaying, via the display, the portion of the second panorama image.

For example, the method may comprise, while displaying the portion of the second panorama image, receiving a scroll input. The method may comprise, based on the scroll input, displaying, via the display, another portion of the second panorama image.

For example, the method may comprise determining the portion of the second panorama image by matching a height of the second panorama image to a height of a display area of the display. The method may comprise displaying, via the display, the portion of the second panorama image.

For example, the electronic device may further comprise at least one sensor configured to obtain sensing values in accordance with a change of a posture of the electronic device. The method may comprise, while displaying the portion of the second panorama image, obtaining, via the at least one sensor, a sensing value. The method may comprise displaying, via the display, another portion of the second panorama image corresponding to the sensing value.

For example, the method may comprise identifying an object representing a light source in the second panorama image. The method may comprise, based on a position of the object in the portion of the second panorama image, displaying a lens flare effect as associated with the object on the portion of the second panorama image.

As described above, a non-transitory computer readable storage medium may store one or more programs. The one or more programs may comprise instructions to, when executed by an electronic device including a display, cause the electronic device to obtain a first panorama image corresponding to a planar panorama image. The one or more programs may comprise instructions to, when executed by the electronic device, cause the electronic device to detect an event to convert the first panorama image to a second panorama image. The one or more programs may comprise instructions to, when executed by the electronic device, cause the electronic device to, based on the detection, obtain a depth value of the first panorama image. The one or more programs may comprise instructions to, when executed by the electronic device, cause the electronic device to obtain a curvature for generating the second panorama image, using the depth value of the first panorama image. The one or more programs may comprise instructions to, when executed by the electronic device, cause the electronic device to, based on the first panorama image, generate the second panorama image in accordance with the curvature. The one or more programs may comprise instructions to, when executed by the electronic device, cause the electronic device to display, via the display, a portion of the second panorama image.

For example, the depth value may be obtained by identifying depth values on objects included in the first panorama image, and by obtaining an average value of the depth values as the depth value of the first panorama image.

For example, the one or more programs may comprise instructions to, when executed by the electronic device, cause the electronic device to, based on the detection, determine, from among objects included in the first panorama image, a reference object. The one or more programs may comprise instructions to, when executed by the electronic device, cause the electronic device to identify a depth value on the reference object. The one or more programs may comprise instructions to, when executed by the electronic device, cause the electronic device to obtain the depth value on the reference object as the depth value of the first panorama image.

For example, the curvature for generating the second panorama image may be inversely proportional to the depth value of the first panorama image.

For example, the second panorama image may be generated by projecting the first panorama image on at least a portion of a cylinder mesh having a radius in accordance with the curvature.

For example, the one or more programs may comprise instructions to, when executed by the electronic device, cause the electronic device to identify a vertical field of view (FOV) of the first panorama image. The one or more programs may comprise instructions to, when executed by the electronic device, cause the electronic device to obtain a cylinder mesh having a radius in accordance with the vertical FOV. The one or more programs may comprise instructions to, when executed by the electronic device, cause the electronic device to, based on projecting the first panorama image on a portion of the cylinder mesh, generate the second panorama image in accordance with the curvature.

For example, the one or more programs may comprise instructions to, when executed by the electronic device, cause the electronic device to obtain first vector data for the first panorama image and second vector data for a second panorama image in accordance with a maximum curvature. The one or more programs may comprise instructions to, when executed by the electronic device, cause the electronic device to generate the second panorama image in accordance with the curvature by applying a first weight inversely proportional to the curvature to the first vector data and applying a second weight proportional to the curvature to the second vector data.

For example, the one or more programs may comprise instructions to, when executed by the electronic device, cause the electronic device to identify a vertical FOV of the first panorama image. The one or more programs may comprise instructions to, when executed by the electronic device, cause the electronic device to, based on the vertical FOV, obtain a reference distance for the second panorama image. The one or more programs may comprise instructions to, when executed by the electronic device, cause the electronic device to display, via the display, the portion of the second panorama image to be viewed at a position separated from the portion of the second panorama image by the reference distance.

For example, the one or more programs may comprise instructions to, when executed by the electronic device, cause the electronic device to, while displaying, via the display, the first panorama image, receive a user input to display the second panorama image. The one or more programs may comprise instructions to, when executed by the electronic device, cause the electronic device to, based on the user input, detect the event.

For example, the one or more programs may comprise instructions to, when executed by the electronic device, cause the electronic device to display, via the display, an animation gradually changed from the first panorama image to the second panorama image. The one or more programs may comprise instructions to, when executed by the electronic device, cause the electronic device to, based on identifying that the animation is terminated, display, via the display, the portion of the second panorama image.

For example, the one or more programs may comprise instructions to, when executed by the electronic device, cause the electronic device to, while displaying the portion of the second panorama image, receive a scroll input. The one or more programs may comprise instructions to, when executed by the electronic device, cause the electronic device to, based on the scroll input, display, via the display, another portion of the second panorama image.

For example, the one or more programs may comprise instructions to, when executed by the electronic device, cause the electronic device to determine the portion of the second panorama image by matching a height of the second panorama image to a height of a display area of the display. The one or more programs may comprise instructions to, when executed by the electronic device, cause the electronic device to display, via the display, the portion of the second panorama image.

For example, the electronic device may further comprise at least one sensor configured to obtain sensing values in accordance with a change of a posture of the electronic device. The one or more programs may comprise instructions to, when executed by the electronic device, cause the electronic device to, while displaying the portion of the second panorama image, obtain, via the at least one sensor, a sensing value. The one or more programs may comprise instructions to, when executed by the electronic device, cause the electronic device to display, via the display, another portion of the second panorama image corresponding to the sensing value.

For example, the one or more programs may comprise instructions to, when executed by the electronic device, cause the electronic device to identify an object representing a light source in the second panorama image. The one or more programs may comprise instructions to, when executed by the electronic device, cause the electronic device to, based on a position of the object in the portion of the second panorama image, display a lens flare effect as associated with the object on the portion of the second panorama image.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
at least one processor comprising processing circuitry;
a display; and
memory comprising one or more storage media storing one or more programs configured to be executed by the at least one processor individually or collectively,
wherein the one or more programs include instructions to cause the electronic device to:
obtain a first panorama image corresponding to a planar panorama image;
detect an event to convert the first panorama image to a second panorama image;
based on the detection, obtain a depth value of the first panorama image;
obtain a curvature for generating the second panorama image using the depth value of the first panorama image;
based on the first panorama image, generate the second panorama image in accordance with the curvature; and
display, via the display, a portion of the second panorama image.

2. The electronic device of claim 1, wherein the depth value is obtained by:
identifying depth values on objects included in the first panorama image; and
obtaining an average value of the depth values as the depth value of the first panorama image.

3. The electronic device of claim 1, wherein the one or more programs include instructions to cause the electronic device to:
based on the detection, determine, from among objects included in the first panorama image, a reference object;
identify a depth value on the reference object; and
obtain the depth value on the reference object as the depth value of the first panorama image.

4. The electronic device of claim 1, wherein the curvature for generating the second panorama image, is inversely proportional to the depth value of the first panorama image.

5. The electronic device of claim 1, wherein the second panorama image is generated by projecting the first panorama image on at least a portion of a cylinder mesh having a radius in accordance with the curvature.

6. The electronic device of claim 1, wherein the one or more programs include instructions to cause the electronic device to:
identify a vertical field of view (FOV) of the first panorama image;
obtain a cylinder mesh having a radius in accordance with the vertical FOV; and
based on projecting the first panorama image on a portion of the cylinder mesh, generate the second panorama image in accordance with the curvature.

7. The electronic device of claim 1, wherein the one or more programs include instructions to cause the electronic device to:
obtain first vector data for the first panorama image and second vector data for a second panorama image in accordance with a maximum curvature; and
generate the second panorama image in accordance with the curvature by applying a first weight inversely proportional to the curvature to the first vector data and applying a second weight proportional to the curvature to the second vector data.

8. The electronic device of claim 1, wherein the one or more programs include instructions to cause the electronic device to:
identify a vertical FOV of the first panorama image;
based on the vertical FOV, obtain a reference distance for the second panorama image; and
display, via the display, the portion of the second panorama image to be viewed at a position separated from the portion of the second panorama image by the reference distance.

9. The electronic device of claim 1, wherein the one or more programs include instructions to cause the electronic device to:
while displaying, via the display, the first panorama image, receive a user input to display the second panorama image; and
based on the user input, detect the event.

10. The electronic device of claim 8, wherein the one or more programs include instructions to cause the electronic device to:
display, via the display, an animation gradually changed from the first panorama image to the second panorama image; and
based on identifying that the animation is terminated, display, via the display, the portion of the second panorama image.

11. The electronic device of claim 1, wherein the one or more programs include instructions to cause the electronic device to:
while displaying the portion of the second panorama image, receive a scroll input; and
based on the scroll input, display, via the display, another portion of the second panorama image.

12. The electronic device of claim 1, wherein the one or more programs include instructions to cause the electronic device to:
determine the portion of the second panorama image by matching a height of the second panorama image to a height of a display area of the display; and
display, via the display, the portion of the second panorama image.

13. The electronic device of claim 1, further comprising at least one sensor configured to obtain sensing values in accordance with a change of a posture of the electronic device,
wherein the one or more programs include instructions to cause the electronic device to:
while displaying the portion of the second panorama image, obtain, via the at least one sensor, a sensing value; and
display, via the display, another portion of the second panorama image corresponding to the sensing value.

14. The electronic device of claim 1, wherein the one or more programs include instructions to cause the electronic device to:
identify an object representing a light source in the second panorama image; and
based on a position of the object in the portion of the second panorama image, display a lens flare effect as associated with the object on the portion of the second panorama image.

15. A method executed in an electronic device comprising a display, the method comprising:
obtaining a first planar panorama image corresponding to a planar panorama image;
detecting an event to convert the first panorama image to a second panorama image;
based on the detection, obtaining a depth value of the first panorama image;
obtaining a curvature for generating the second panorama image using the depth value of the first panorama image;
based on the first panorama image, generating the second panorama image in accordance with the curvature; and
displaying, via the display, a portion of the second panorama image.

16. The method of claim 15, wherein the depth value is obtained by:
identifying depth values on objects included in the first panorama image; and
obtaining an average value of the depth values as the depth value of the first panorama image.

17. The method of claim 15, the method comprising:
based on the detection, determining, from among objects included in the first panorama image, a reference object;
identifying a depth value on the reference object; and
obtaining the depth value on the reference object as the depth value of the first panorama image.

18. The method of claim 15, the method comprising:
identifying an object representing a light source in the second panorama image;
obtaining a lens flare effect using a coordinate of the object representing the light source in a 3D space; and
displaying, via the display, the lens flare effect as associated with the object on the portion of the second panorama image using the coordinate of the object.

19. The method of claim 15, wherein the lens flare effect differs based on a position of the object representing the light source in the second panorama image.

20. One or more non-transitory computer readable storage medium storing one or more programs, the one or more programs comprising instructions to, when executed by an electronic device with a display, cause the electronic device to:
obtain a first panorama image corresponding to a planar panorama image;
detect an event to convert the first panorama image to a second panorama image;
based on the detection, obtain a depth value of the first panorama image;
obtain a curvature for generating the second panorama image using the depth value of the first panorama image;
based on the first panorama image, generate the second panorama image in accordance with the curvature; and
display, via the display, a portion of the second panorama image.
